(19) United States
(12) Patent Application Publication
(10) Pub. No.: US 2012/0075674 A1
(43) Pub. Date: Mar. 29, 2012

(54) Medical monitoring telephony communication device and method

(76) Inventor: Robert Sweeney, Parkville, MO (US)

(21) Appl. No.: 13/373,636

(22) Filed: Nov. 22, 2011

Related U.S. Application Data
(63) Continuation-in-part of application No. 13/065,281, filed on Mar. 18, 2011.
(60) Provisional application No. 61/399,723, filed on Jul. 16, 2010.

(51) Int. Cl. G06K 15/02

(52) U.S. Cl. 358/1.15

(57) ABSTRACT

An apparatus and method of operating a mobile communications device includes a text message receiver and a printer for printing text messages, the method including the steps of; providing a medical monitoring device and receiving a data reading from a medical monitoring device with a text message communications device. The method also includes the steps of assembling a first message identifying a user, the medical monitoring device and the text communications device, and sending the first message to a remote healthcare professional via secure text message. Then receiving a second message back from the remote health care professional and printing the second message for a patient for example and returning acknowledgement of the second message back to a health care provider such as a doctor for example.

### CROSS REFERENCES TO RELATED APPLICATIONS

Applicant claims priority under 35 USC 119 to provisional application 61/399723 filed Jul. 16, 2010 with the title “Dedicated SMS Enterprise Communication printer device and method” and is a continuation in part of application No. 13/065,281 titled “Dedicated SMS Enterprise Communication printer device and method”.

Statement as to Rights to inventions made under Federally sponsored research and development:

Not applicable.

### BACKGROUND OF THE INVENTION

1. Field of the Invention

This present invention relates generally to text messages, SMS and wireless data communication.

2. Background Information

In the communication industry it is common to use cell phones for mobile communication and to receive text messages. A problem with existing technology is that it can be overly complicated for the elderly and disabled and other users and often the small buttons and small screens of cell phone devices are difficult to use for those who are elderly or disabled. Further as it relates to mobile devices there is a need in many applications for tangible documentation that cell phones and other mobile devices do not provide.

### SUMMARY OF THE INVENTION

The present invention solves the problems outlined above. A method and device for operating a mobile communications system includes a text message receiver and a printer for printing text messages. The method includes the steps of;

providing a website connected to the Internet, and receiving an automatic message from the website. The message including an electronic serial number. The method assigns a mobile phone number to the device based on the electronic serial number and sends the phone number to the device and automatically printing out the phone number. The device includes a holder for displaying the phone number label on an exterior surface of the device housing. The device receives and prints text messages or other material and allows the user to have at least one action button that might send greetings, reply or send an urgent message in an emergency for example. The action button could be programmed to perform other actions.

### BRIEF DESCRIPTION OF THE DRAWINGS

FIG. 1 is a view of one embodiment of the device;

FIG. 2 shows one possible relational diagram for the device;

FIG. 3 shows a flow chart for the device operation;

FIG. 4 shows a diagram of the device,

FIG. 5 shows a flowchart for the device, and

FIG. 6 shows an alternate relational diagram for the device.

### DESCRIPTION OF THE PREFERRED EMBODIMENTS

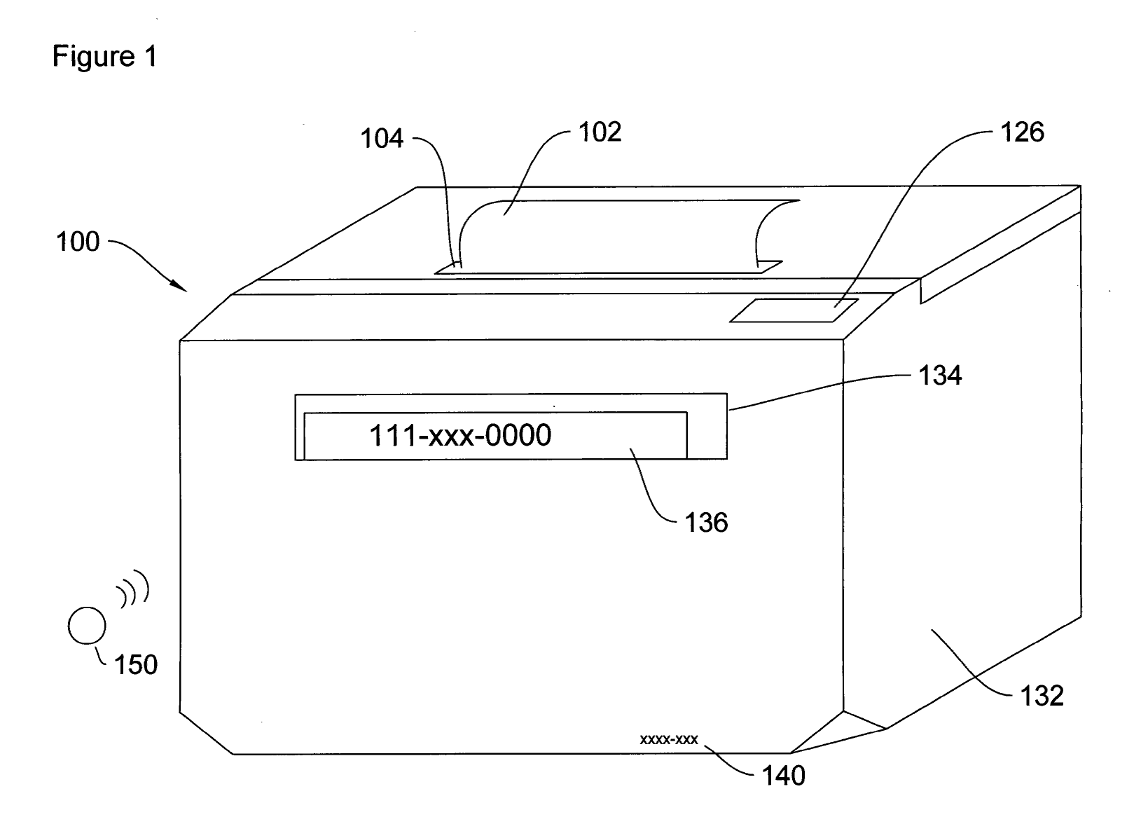

FIG. 1 illustrates a preferred embodiment of a communication device 100 using the invention. The device 100 receives wireless signals such as SMS, text messages and wireless data communications for example. The device 100 includes an internal printer that can print messages 102 or other material on hard copy such as a thermal paper and can be battery powered for remote use. The printer device 100 includes a slot 104 that a printed message 102 comes through and a lighted action button 126 that can light and flash green when a message arrives or needs to be acknowledged, this light can be separate or can be incorporated into the action button 126. There can be additional lights such as two smaller lights on the left side: one solid blue light that indicates a good wireless connection, and the other is a flashing red light, that, when lit, indicates out of paper for example. The device 100 can include a speaker that can pronounce messages such as reminders to take medicine and it can produce a sound such as a tweet when a message is waiting. The device 100 includes at least one action button 126 and could include more. The lighted action button 126 can send a reply to acknowledge receipt of a message or to participate in a survey for example. A second button could send a special message such as an urgent warning. For example, the button might automatically send a warning message from an elderly owner to an adult child that the owner needs help. For example, if an adult child sends the elder owner a text message the owner can acknowledge receipt of the message by pressing the reply action button 126. The action button 126 can be programmed to serve other functions, for example the device 100 could be set up as a remote financial terminal that could send payment information, receive verification of funds availability, ask for and send transaction verification and print out a receipt for the customer and transaction information for the user. Alternatively the device 100 could have only one button to send a message to acknowledge receipt of a message back to the sender of the message. The device 100 includes a cube shaped housing 132 and has a transparent holder 134 on the housing 132. The holder 134 can hold a printed message 136 and/or other indicia such as a person's name. The housing 132 includes an electronic serial number 140 prominently displayed on the outside. For example, the serial number can be displayed on a label affixed to the bottom of the device 100.

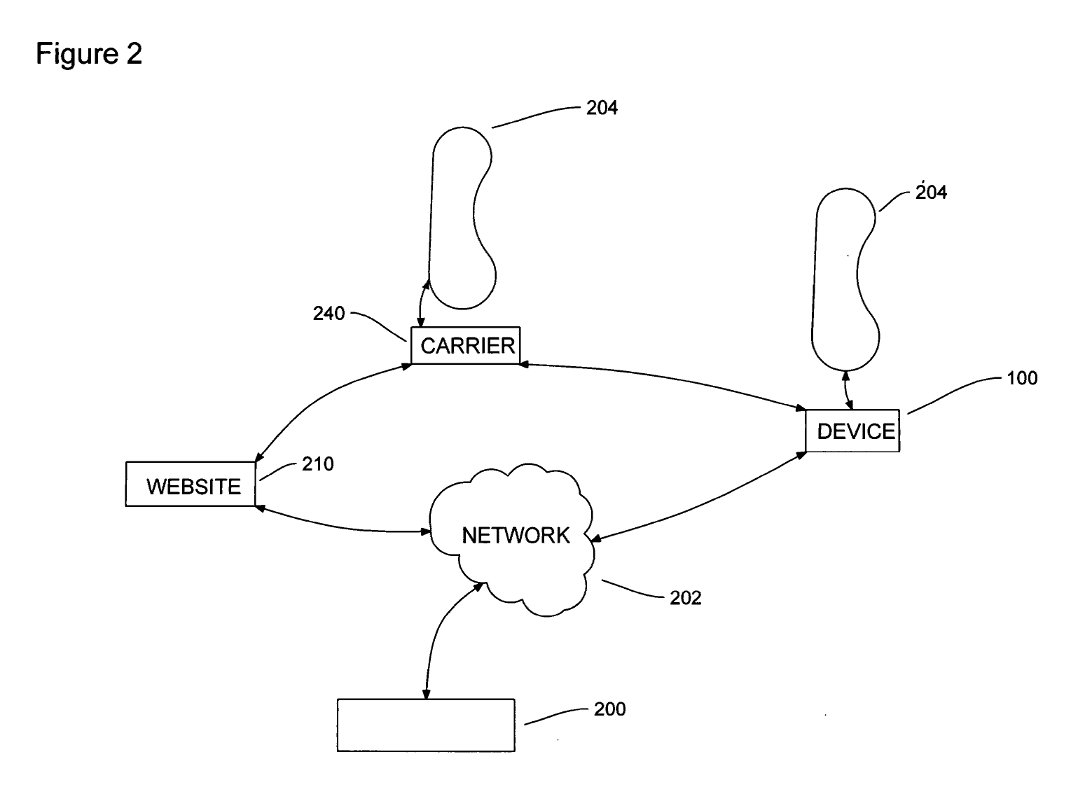

FIG. 2 shows a first possible relational diagram for the device 100. The device 100 can be programmed through a computer 200 directly or via a communication network 202 like a wireless carrier or a public network like the internet. The website 210 can automatically access a device 100 through the Internet 202 or a wireless cellular data network. A communication device such as cell phone 204 can send a text message via SMS to the device 100 and the contents of the text message will be printed out. When the device 100 is purchased, turned on and connected to the Internet 202 it will connect automatically to a website 210 that will download a phone number from a cell phone carrier 240 and the website will send that number to the device via the Internet 202 and the number will print out on the device 100.

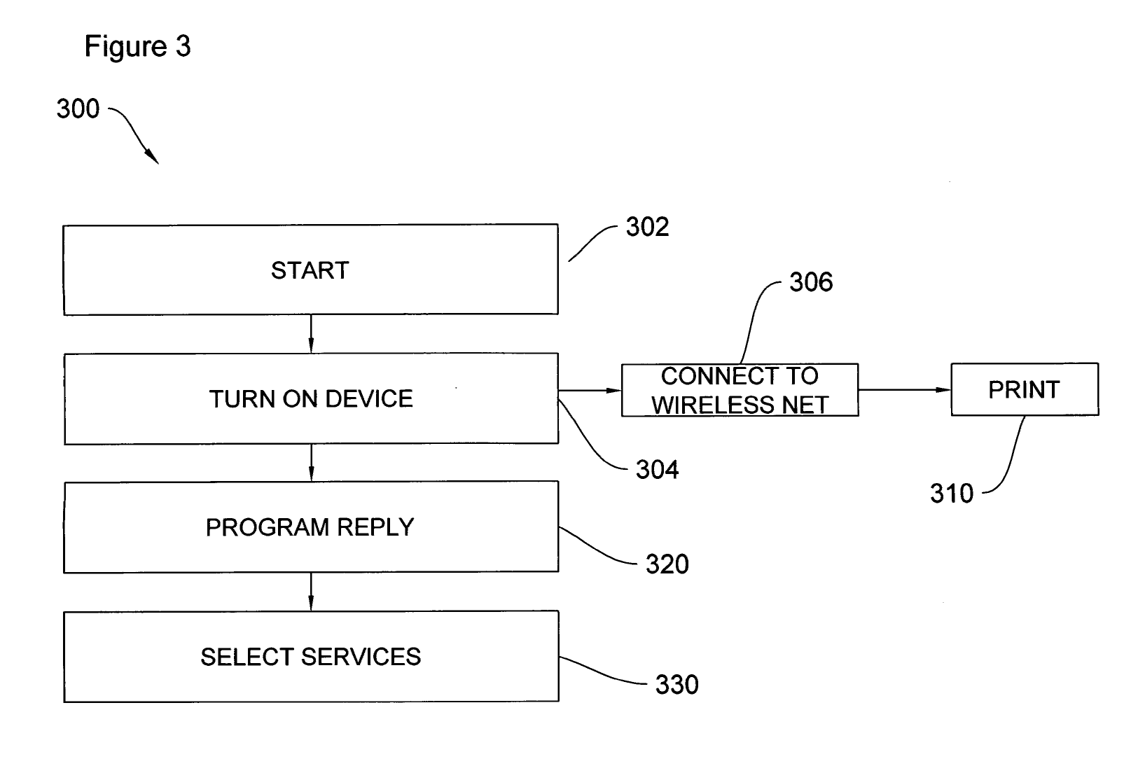

FIG. 3 shows a flow chart for the start up process 300 for this device 100. The flow chart 300 process starts 302 with a user getting the device 100 such as buying it at the store or receiving it through the mail or can start at the time of manufacture for example. The user will turn the power on 304 and connect 306 the device 100 into a wireless cellular data network. The device 100 is ‘hot’ in that when connected to the wireless cellular data network and turned on 304 it will automatically connect via the wireless cellular data network 202 to a website 240 specific to the product. The website 240 will prompt the user through a series of registration screens and will ask for the user's electronic serial number 140 and zip code. Based on the unique electronic serial number and zip code the website will communicate via the wireless cellular network and assign the device 100 a phone number from a cell phone carrier 240 using over the air configuration. The device 100 will then automatically print 310 its phone number to form a label 136 that can be displayed on the device 100 so that an elder user will always know the phone number. The mobile phone number will also be retained by the website 240 and can be retrieved by entering the electronic serial number and/or a password. While connected to the website 210 a user can program user button 126. The user can program a reply 320 if needed and select the users to receive that text message whenever the button 126 is pushed. The user will also have the option to select to receive services 330 such as coupons that would print out on the device, weather alerts, amber alerts or other information service options.

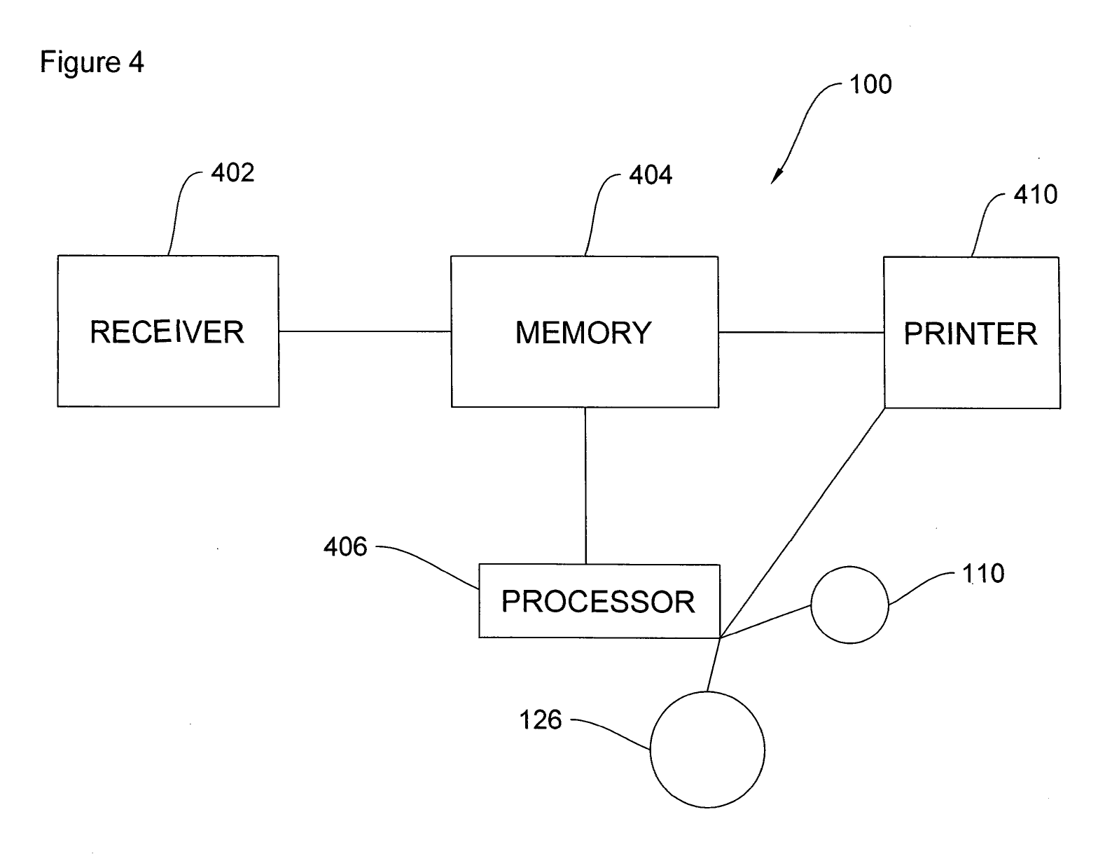

FIG. 4 shows a diagram of the device 100. The device 100 includes a communication module receiver 402 that has a mobile phone number. The receiver 402 saves a message in a memory 404. A processor 406 will pull incoming text messages from the memory 404 and send them to a printer 410, the processor 406 will also allow the senders phone number to print out on the message. The receiver 402 also receives text messages from a website 210, these text messages include data to program button 126 messages. The text messages for these outputs are also stored in the memory 404 and are sent out to lists of recipients also sent from the website 210 and stored in the memory 404. The process by which a user may create a phonebook in device 100 by entering names and numbers into a website, then using wireless cellular data communication, the website calls device 100 and stores the phonebook entries in memory 404. Then , when a user receives a text message from a number listed in their phone book, both the name and the number of the sender is printed 102.

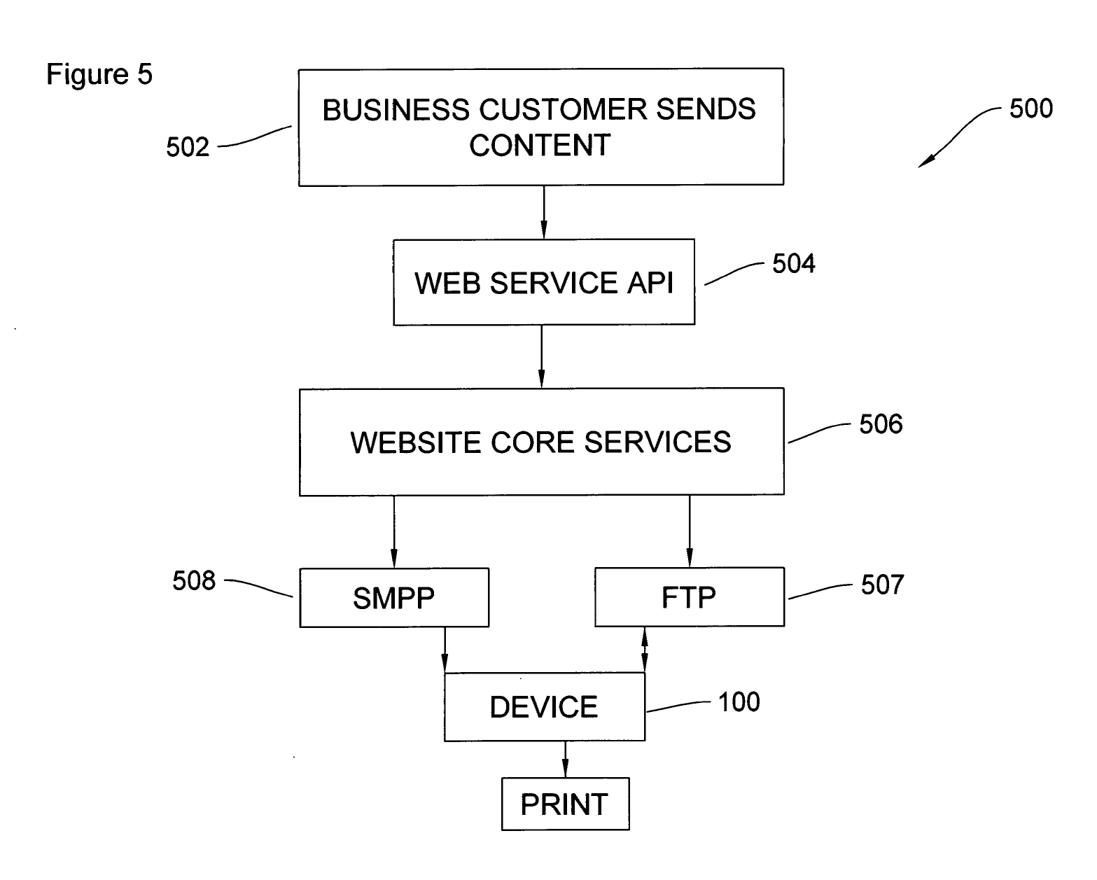

FIG. 5 shows an alternate business flow process 500 using the device 100. A source such as a business customer wants to send 502 an HTML or XML message to one or several devices 100. For example, a customer may have a coupon to send to a plurality of device users who have chosen to receive coupons from this business. The business customer will use a device application programming interface (API) 504 to post a graphic file and message via web service to web core services 506. A sample message might be:

<doc>
<img src=”client_logo.png”/>
<b>SPECIAL OFFER</b>br
Show this coupon and receive $10
off the purchase of 1-month supply
of your prescription medication.
<barcode values “2500274135”/>
</doc

The HTML or XML message request from the business customer is received by core services 506. Core services 506 turns the message into a text and/or graphic file on a File Transfer Protocol (FTP). The FTP file for the sample message would look like:

File:”c234” created on FTP server.
SPECIAL OFFER
Show this coupon and receive 1-month supply of
Your prescription medication.
mQ#0830 (i.e. Barcode cmd) 2500274135

Once the HTML or XML file is created and saved as file c234, the core service will send an SMS message 508 such as: SMS=mQ#09234 to the device 100 via a direct wireless carrier peer to peer connection (SMPP). The device 100 will then send a request to the FTP server (in this case ‘c234’ via a wireless cellular data connection). File ‘c234’ is returned via a wireless cellular data connection then printed. In this case the user would receive a printed coupon identifying a business and offering $10 off the purchase of a 1 month supply of medicine. The coupon would be printed to display a graphic logo at the top and a barcode at the bottom. Using the Web Service API 504, a business customer 502 may also send an HTML or XML file directly to device 100. This file is received by 402, stored in memory 404, then processed 406 automatically by device 100 by communicating via the wireless data network to the Internet, capturing one or more graphic files and then assembling a file that includes graphics and text to be printed on device 100. The file for the sample message might look like:

<doc>
Get Your Free Drink Today !!
<img src=http://website.at/software/dither/dither1.png/>
This healthy choice brought
To you by ABC Stores!!
<img src=http://trade.mar.cx/images/WX7654321/>
</doc>

After the startup process 300 the device 100 will be turned on ready to use and does not require Internet connection. In use if the device 100 receives a text message and the green light will display and the message will print out at printer slot 104, the message can include the phone number and name of the sender which is stored in the memory. By printing the phone number and name with the message the user can identify the sender and has the option to call the sender to respond to the message. If more messages are received they will print in order on the paper 102 until the paper 102 is torn off to be read. When the messages are read the user can press the reply button 126 to acknowledge message receipt to the last phone number from which a message was received. The user can also press button 126 to advance the paper through slot 104. The acknowledgement message can be in the form of a pre-recorded text message. The reply serves to assure the message sender such as an adult child that there elderly parent is OK. If no reply is needed the message sender can simply say no response required in their message and the device 100 user always has the option not to send a response. If the user opts in for message services they might receive weather reports, coupons or reminders such as to take medicine for example.

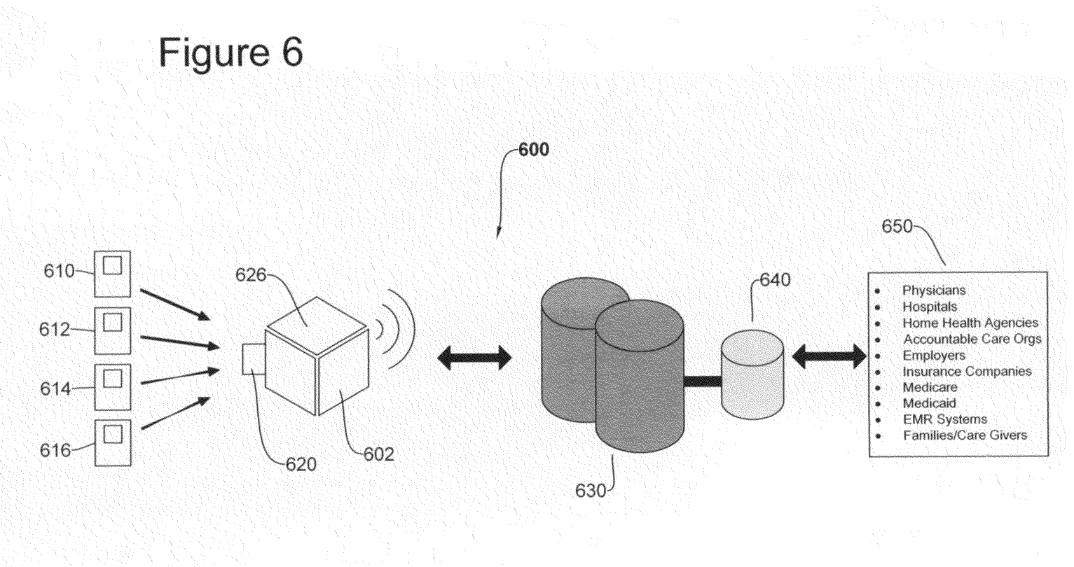

FIG. 6 shows an alternate relational diagram 600 using the message cube device 602. A person uses a medical monitoring device (610, 612, 614, 616) and creates a personal health reading (vital sign) and connects to the message cube device 602 using wireless technology such as Bluetooth® for example. Each monitoring device (610, 612, 614, 616) is matched to the message cube 602 so that the message cube automatically recognizes the monitoring device (610, 612, 614, 616) and assigns readings from the monitor device to the individual being monitored. When a reading is taken, the message cube 602 will assemble a message that identifies the specific monitoring device (610, 612, 614, 616) by a serial number for example, the specific user by name for example and the message cube by a unique serial number 136, or 140 for example. The message assembled is then sent to a communications gateway 630, the gateway 630 identifies the message cube device 602, the user and the monitor device (610, 612, 614, 616) and using a software application 640 securely communicates a report to health care providers 650. The health care provider 650 can then post a message back to the user to acknowledge the reading, report progress towards a goal or provide encouragement for example. Once a message is received back from the health care provider 650 the message cube device 602 can print out the message and prompts the user to touch flashing green lighted button 126 as acknowledgement the user received the message. The message cube device 602 returns the acknowledgement message through the gateway 630 and is logged in the users records such as a medical record for example.

It will be obvious to those skilled in the art that modifications may be made to the embodiments described above without departing from the scope of the invention. Thus the scope of the invention should be determined by the claims in the formal application and their legal equivalents, rather than by the examples given.

I claim:

1. A method of operating a mobile communications device includes a text message receiver and a printer for printing text messages, the method including the steps of;
providing at least one medical monitoring device,
receiving a data reading from said medical monitoring device with a text message communications device,
assembling a first message identifying a user, the medical monitoring device and the text communications device,
sending the first message to a remote healthcare professional via secure text message,
receiving a second message back from said remote health care professional and printing said second message,
returning acknowledgement of said second message.

2. The method of claim 1 wherein said data reading includes data that specifically identifies a user and said medical monitoring device.

3. The method of claim 1 wherein the step of sending the first message includes a step of recording the data reading in a user's records.

4. The method of claim 1 wherein the step of receiving the second message includes setting a flashing light that encourages said step of returning acknowledgement.

5. The method of claim 1 wherein said medical monitoring device is one of a blood pressure cuff, a weight scale, a glucometer or a pulse oximeter.

6. A method of operating a mobile communications device includes an SMS message receiver and a printer for printing SMS messages, the method including the steps of;
providing at least one medical monitoring device paired with said mobile communications device,
receiving a data reading from said medical monitoring device with the SMS message receiver,
assembling a first message identifying a user, the medical monitoring device and the SMS message receiver,
sending the first message to a remote healthcare database via SMS message,
receiving a second message back from a remote health care professional and printing said second message,
returning acknowledgement of said second message.

7. The method of claim 6 wherein said data reading includes data that specifically identifies a user.

8. The method of claim 6 wherein said data reading includes data that identifies the medical monitoring device.

9. The method of claim 6 wherein the step of sending the first message includes a step of recording the data reading in a user's health records.

10. The method of claim 7 wherein the step of receiving the second message includes setting a flashing light that encourages said step of returning acknowledgement.

11. The method of claim 9 wherein said medical monitoring device is one of a blood pressure cuff, a weight scale, a glucometer or a pulse oximeter.

12. A mobile communications device includes
an SMS mobile communications device and a printer for printing SMS messages,
at least one medical monitoring device paired with said mobile communications device,
said medical monitoring device with the SMS message receiver adapted to receive a data signal from said medical monitoring device including a medical reading,
a remote healthcare receiver adapted to receive a second data signal from said SMS mobile communications device wherein said second data signal includes said medical reading, a user's identity, a code indicating the identity of said medical monitoring device and a code identifying the mobile communications device,
wherein said healthcare receiver sends a third signal acknowledging receipt of said second signal and wherein said SMS mobile communications device includes a button adapted to send a fourth SMS message acknowledging receipt of said third message.

13. The device of claim 12 wherein said medical monitoring device is one of a blood pressure cuff, a weight scale, a glucometer or a pulse oximeter.
